(19) United States
(12) Patent Application Publication
(10) Pub. No.: US 2024/0349304 A1
(43) Pub. Date: Oct. 17, 2024

(54) RANDOM RESOURCE SELECTION ENHANCEMENT WITH SUBSET SENSING

(71) Applicant: QUALCOMM Incorporated, San Diego, CA (US)

(72) Inventors: Hui GUO, Beijing (CN); Tien Viet NGUYEN, Bridgewater, NJ (US); Shuanshuan WU, San Diego, CA (US); Sourjya DUTTA, San Diego, CA (US); Gabi SARKIS, San Diego, CA (US); Kapil GULATI, Belle Mead, NJ (US)

(21) Appl. No.: 18/294,527

(22) PCT Filed: Sep. 30, 2021
(86) PCT No.: PCT/CN2021/122156

§ 371 Date: Feb. 1, 2024

(51) Int. Cl. H04W 72/25; H04B 17/318; H04W 74/0833

(52) U.S. Cl. CPC H04W 72/25; H04B 17/328; H04W 74/0833

(57) ABSTRACT

A user equipment (UE) monitors at least one resource subset in a set of resource subsets configured for random selection of a SL transmission resource. The UE selects, based on the monitoring of the at least one resource subset, a resource subset in the set of resource subsets configured for the random selection of the sidelink transmission resource. The UE transmits a sidelink message in a randomly selected transmission resource within the selected resource subset.

### INTRODUCTION

The present disclosure relates generally to communication systems, and more particularly, to sidelink (SL) communication.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some aspects of wireless communication may comprise direct communication between devices based on sidelink. There exists a need for further improvements in sidelink technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method of wireless communication is provided. The method includes monitoring at least one resource subset in a set of resource subsets configured for random selection of a sidelink transmission resource. The method also includes selecting, based on the monitoring of the at least one resource subset, a resource subset in the set of resource subsets configured for the random selection of the sidelink transmission resource. The method further includes transmitting a sidelink message in a randomly selected transmission resource within the selected resource subset.

In another aspect of the disclosure, an apparatus for wireless communication is provided. The apparatus includes memory and at least one processor coupled to the memory, the memory and the at least one processor being configured to monitor at least one resource subset in a set of resource subsets configured for random selection of a sidelink transmission resource. The at least one processor further being configured to select, from the at least one resource subset monitored by the UE, a resource subset in the set of resource subsets configured for the random selection of the sidelink transmission resource. The at least one processor also being configured to transmit a sidelink message in a randomly selected transmission resource within the selected resource subset.

In an aspect of the disclosure, an apparatus for wireless communication is provided. The apparatus including means for monitoring at least one resource subset in a set of resource subsets configured for random selection of a sidelink transmission resource. The apparatus also including means for selecting, based on the monitoring of the at least one resource subset, a resource subset in the set of resource subsets configured for the random selection of the sidelink transmission resource. The apparatus further including means for transmitting a sidelink message in a randomly selected transmission resource within the selected resource subset.

In an aspect of the disclosure, a non-transitory computer-readable storage medium is provided. The non-transitory computer-readable storage medium storing computer executable code at a user equipment (UE), the code when executed by a processor causes the processor to: monitor at least one resource subset in a set of resource subsets configured for random selection of a sidelink transmission resource. The program stored by the non-transitory computer-readable storage medium may further include code to select, from the at least one resource subset monitored by the UE, a resource subset in the set of resource subsets configured for the random selection of the sidelink transmission resource. The program stored by the non-transitory computer-readable storage medium may also include code to transmit a sidelink message in a randomly selected transmission resource within the selected resource subset.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with aspects presented herein.

FIG. 2 illustrates example aspects of a sidelink slot structure, in accordance with aspects presented herein.

FIG. 3 is a diagram illustrating an example of a first device and a second device involved in wireless communication based, e.g., on sidelink, in accordance with aspects presented herein.

FIG. 4 illustrates example aspects of sidelink communication between devices, in accordance with aspects presented herein.

FIG. 5 illustrates examples of resource reservation for sidelink communication, in accordance with aspects presented herein.

FIG. 6 illustrates example aspects of sidelink resource selection, in accordance with aspects presented herein.

FIG. 6 illustrates example aspects of sidelink resource selection, in accordance with aspects presented herein.

FIGS. 7A and 7B illustrate example timing aspects of sidelink resource sensing and selection, in accordance with aspects presented herein.

FIG. 8 illustrates examples of resource reservation for sidelink communication, in accordance with aspects presented herein.

FIG. 9 is an example communication flow between UEs, in accordance with aspects presented herein.

FIG. 10 illustrates example aspects of resource subsets for random selection, in accordance with aspects presented herein.

FIG. 11 is an example communication flow between UEs, in accordance with aspects presented herein.

FIG. 12 is a flowchart of a method of wireless communication, in accordance with aspects presented herein.

FIG. 13 is a flowchart of a method of wireless communication, in accordance with aspects presented herein.

FIG. 14 is a diagram illustrating an example of a hardware implementation for an example apparatus, in accordance with aspects presented herein.

### DETAILED DESCRIPTION

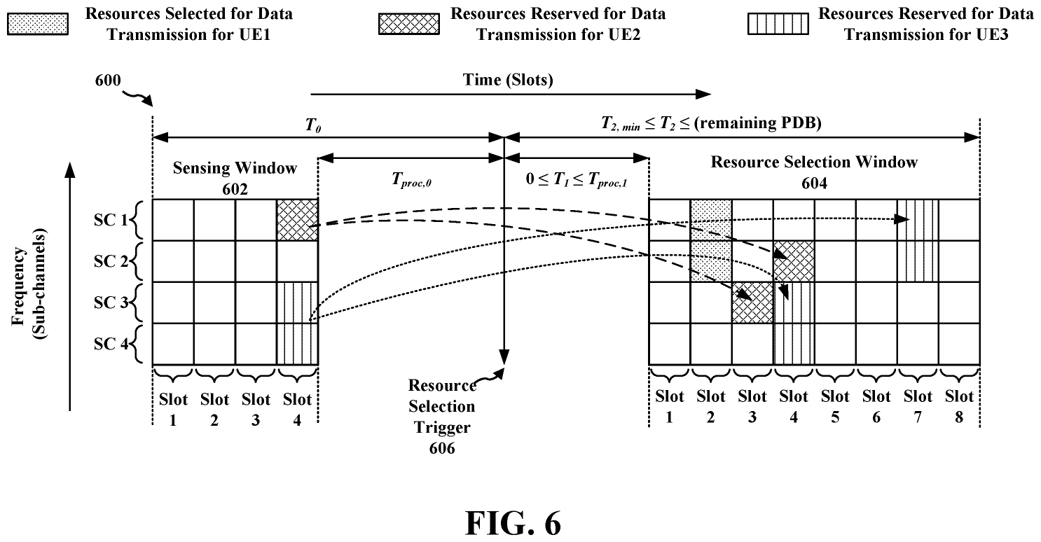

Sidelink communication may be based on different types or modes of resource allocation mechanisms. In a first resource allocation mode (which may be referred to herein as “Mode 1”), centralized resource allocation may be provided by a network entity. For example, a base station may determine resources for sidelink communication and may allocate resources to different UEs to use for sidelink transmissions. In a second resource allocation mode (which may be referred to herein as “Mode 2”), distributed resource allocation may be provided. In Mode 2, each UE may autonomously determine resources to use for sidelink transmission. The autonomous resource selection for transmitting sidelink data, in some aspects, may be based on one of a full-sensing-based resource selection configuration, a partial-sensing-based resource selection configuration, or a random resource selection configuration each of which is described below in relation to FIGS. 6-8 below. As an example, in order to coordinate the selection of sidelink resources by individual UEs, each UE may use a sensing technique to monitor for resource reservations by other sidelink UEs and may select resources for sidelink transmissions from unreserved resources. The sensing technique may include one or more of monitoring for resource reservations of potential resources from other devices or performing signal measurements on potential resources. Examples aspects of sensing are described in connection with FIG. 6. In other aspects, a UE may randomly select resources for a sidelink transmission without sensing for other resource reservations. The different resource selection configurations (e.g., sensing based selection or random selection) may be used based on power saving considerations for the UE or a criticality of the sidelink transmission. For example, the UE may save power in random resource selection, because the UE may select the resource without performing sensing. The UE may select a resource with less interference if the UE selects the resource based on sensing, e.g., after monitoring for resource reservations of the same by other UEs and/or performing measurements for the resource. As a random resource selection configuration may not be preceded by a sensing operation, the UE may select resources that overlap with resources selected by another UE. Aspects presented herein provide for conflict or collision reduction even when a UE selects transmission resources based on a random resource selection. The aspects may help to prevent conflicts between randomly selected resources that are selected from a same resource pool used by UEs performing one of full-sensing-based or partial-sensing-based resource selection. As presented herein, the UE may monitor resource subsets that are configured for random selection of sidelink transmission resources, and may select one of the resource subsets based on the monitoring. After selecting the resource subset, the UE may randomly select sidelink transmission resources from within the resource subset. By selecting the resource subset based on monitoring, the UE may select a resource subset that has fewer conflicts or collisions while conserving energy at a UE by performing the random resource selection rather than sensing based resource selection within the selected resource subset.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more examples, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described aspects may occur. Implementations may range a spectrum from chip-level or modular components to non-modular, non-chip-level implementations and further to aggregate, distributed, or original equipment manufacturer (OEM) devices or systems incorporating one or more aspects of the described aspects. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, end-user devices, etc. of varying sizes, shapes, and constitution.

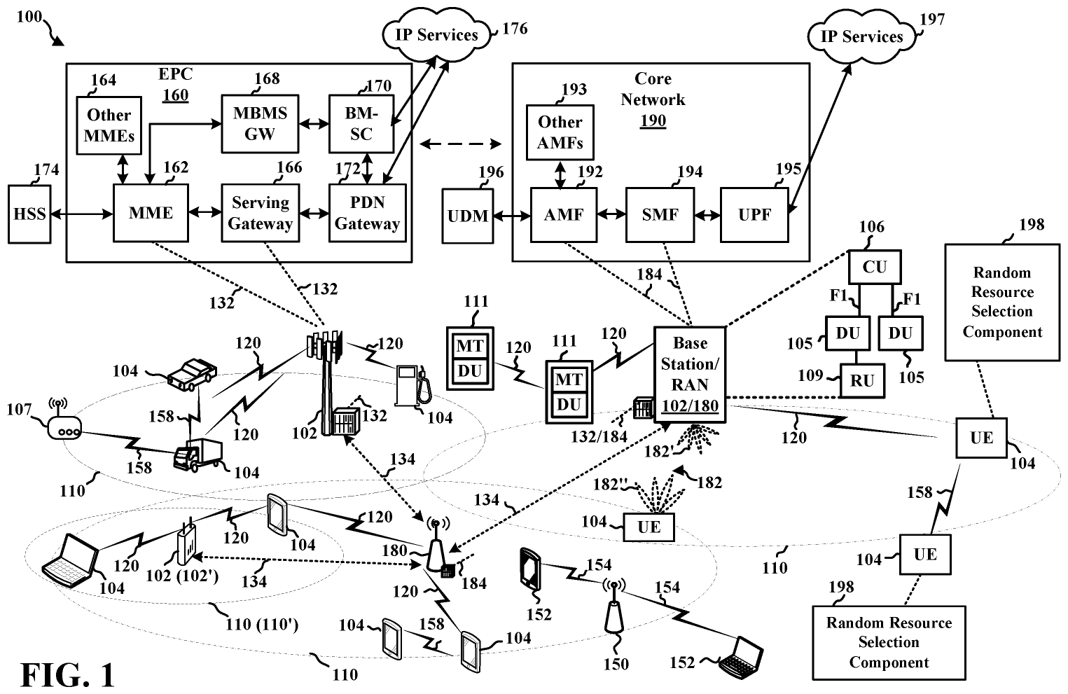

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

A link between a UE 104 and a base station 102 or 180 may be established as an access link, e.g., using a Uu interface. Other communication may be exchanged between wireless devices based on sidelink. For example, some UEs 104 may communicate with each other directly using a device-to-device (D2D) communication link 158. In some examples, the D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

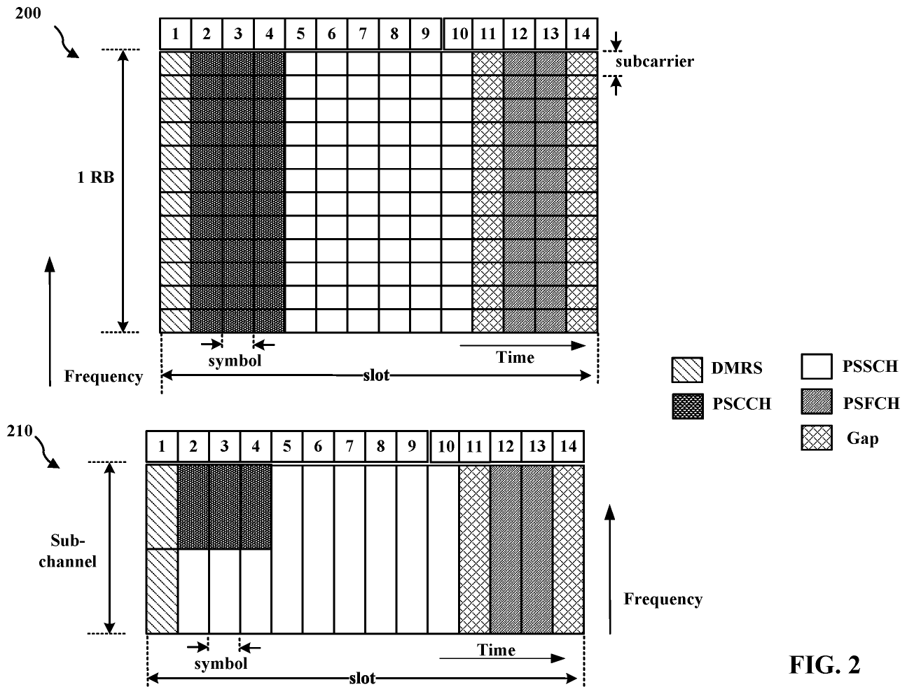

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 2. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

Referring again to FIG. 1, in certain aspects, the UE 104 may include a random resource selection component 198 that may be configured to monitor at least one resource subset in a set of resource subsets configured for random selection of a sidelink transmission resource, select a resource subset in the set of resource subsets configured for the random selection of the sidelink transmission resource based on the monitoring of the at least one resource subset, and transmit a sidelink message in a randomly selected transmission resource within the selected resource subset. Although the following description may be focused on 5G NR, the concepts described herein may be applicable to other similar areas, such as LTE, LTE-A, CDMA, GSM, and other wireless technologies.”

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184 (e.g., an Xn interface), and the third backhaul links 134 may be wired or wireless.

In some aspects, a base station 102 or 180 may be referred as a RAN and may include aggregated or disaggregated components. As an example of a disaggregated RAN, a base station may include a central unit (CU) 106, one or more distributed units (DU) 105, and/or one or more remote units (RU) 109, as illustrated in FIG. 1. A RAN may be disaggregated with a split between an RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs 105 may be connected via an F1 interface. A DU 105 and an RU 109 may be connected via a fronthaul interface. A connection between the CU 106 and a DU 105 may be referred to as a midhaul, and a connection between a DU 105 and an RU 109 may be referred to as a fronthaul. The connection between the CU 106 and the core network may be referred to as the backhaul. The RAN may be based on a functional split between various components of the RAN, e.g., between the CU 106, the DU 105, or the RU 109. The CU may be configured to perform one or more aspects of a wireless communication protocol, e.g., handling one or more layers of a protocol stack, and the DU(s) may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. A CU 106 may host higher layer functions, e.g., above the RLC layer, such as a service data adaptation protocol (SDAP) layer, a packet data convergence protocol (PDCP) layer. In other implementations, the split between the layer functions provided by the CU, DU, or RU may be different.

An access network may include one or more integrated access and backhaul (IAB) nodes 111 that exchange wireless communication with a UE 104 or other IAB node 111 to provide access and backhaul to a core network. In an IAB network of multiple IAB nodes, an anchor node may be referred to as an IAB donor. The IAB donor may be a base station 102 or 180 that provides access to a core network 190 or EPC 160 and/or control to one or more IAB nodes 111. The IAB donor may include a CU 106 and a DU 105. IAB nodes 111 may include a DU 105 and a mobile termination (MT). The DU 105 of an IAB node 111 may operate as a parent node, and the MT may operate as a child node.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum often is subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming. Similarly, beamforming may be applied for sidelink communication, e.g., between UEs.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although this example is described for the base station 180 and UE 104, the aspects may be similarly applied between a first and second device (e.g., a first and second UE) for sidelink communication.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. A numerology defines a subcarrier spacing (SCS) and, effectively, the symbol length/duration, which is equal to 1/SCS. The symbol length/duration is inversely related to the subcarrier spacing.

Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may include control information in PSCCH and some REs may include demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LBT symbols may be different than the example illustrated in FIG. 2. Multiple slots may be aggregated together in some aspects.

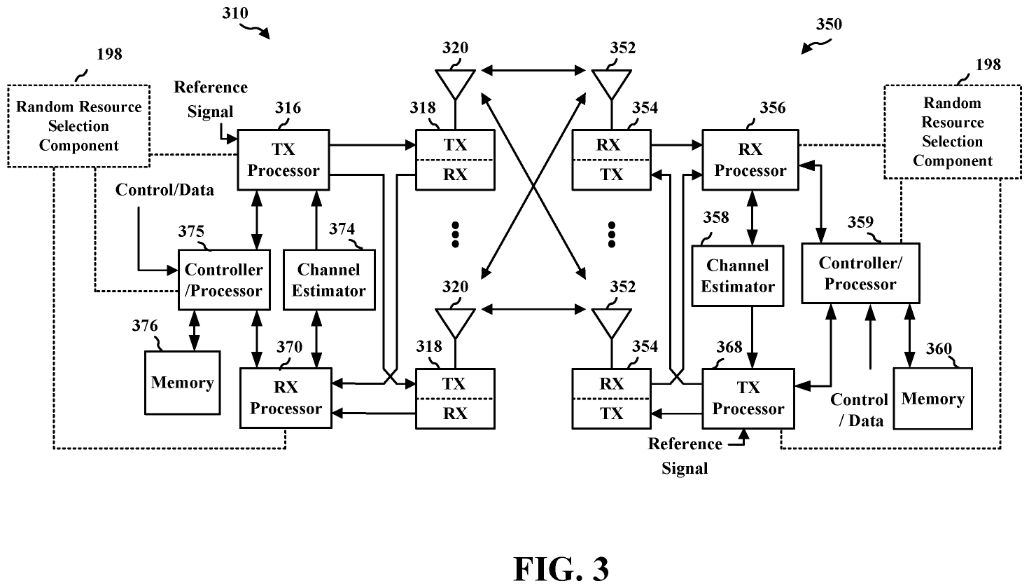

FIG. 3 is a block diagram of a first wireless communication device 310 in communication with a second wireless communication device 350. The communication may be based on sidelink or an access link. In some examples, the devices 310 and 350 may communicate based on sidelink such as V2X or other D2D communication. In other aspects, the devices 310 and 350 may communication over an access link based on uplink and downlink transmissions. The communication may be based on sidelink using a PC5 interface (e.g., between two UEs). The communication may be based on an access link using a Uu interface (e.g., between a base station and a UE). The devices 310 and the 350 may comprise a UE, an RSU, a base station, etc. In some implementations, the device 310 may correspond to a base station and the device 350 may correspond to a UE. In other implementations Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318 TX. Each transmitter 318 TX may modulate a radio frequency (RF) carrier with a respective spatial stream for transmission.

At the device 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354 TX. Each transmitter 354 TX may modulate an RF carrier with a respective spatial stream for transmission.

The transmission is processed at the device 310 in a manner similar to that described in connection with the receiver function at the device 350. Each receiver 318 RX receives a signal through its respective antenna 320. Each receiver 318 RX recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 198 of FIG. 1.

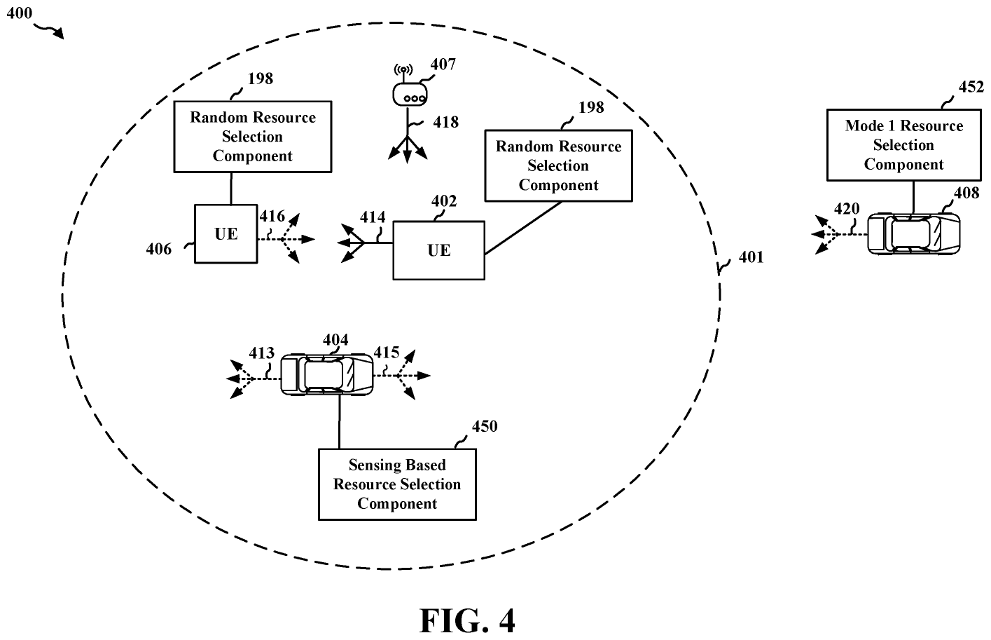

FIG. 4 illustrates an example 400 of sidelink communication between devices. The communication may be based on a slot structure comprising aspects described in connection with FIG. 2. For example, the UE 402 may transmit a sidelink transmission 414, e.g., comprising a control channel (e.g., PSCCH) and/or a corresponding data channel (e.g., PSSCH), that may be received by UEs 404, 406, 408. A control channel may include information (e.g., sidelink control information (SCI)) for decoding the data channel including reservation information, such as information about time and/or frequency resources that are reserved for the data channel transmission. For example, the SCI may indicate a number of TTIs, as well as the RBs that will be occupied by the data transmission. The SCI may also be used by receiving devices to avoid interference by refraining from transmitting on the reserved resources. The UEs 402, 404, 406, 408 may each be capable of sidelink transmission in addition to sidelink reception. Thus, UEs 404, 406, 408 are illustrated as transmitting sidelink transmissions 413, 415, 416, 420. The sidelink transmissions 413, 414, 415, 416, 420 may be unicast, broadcast or multicast to nearby devices. For example, UE 404 may transmit communication 413, 415 intended for receipt by other UEs within a range 401 of UE 404, and UE 406 may transmit communication 416. Additionally, or alternatively, RSU 407 may receive communication from and/or transmit communication 418 to UEs 402, 404, 406, 408. One or more of the UEs 402, 404, 406, 408 or the RSU 407 may comprise a random resource selection component 198 as described in connection with FIG. 1.

One of more of the UEs may communication using a Mode 1, centralized resource allocation in which sidelink resources are allocated by a network or central entity. As an example, the UE 408 may include a mode 1 resource selection component 452 that transmits sidelink communication using allocated sidelink resources. Other UEs may use a “Mode 2”, distributed resource allocation for sidelink transmissions. In Mode 2, each UE may autonomously determine resources to use for sidelink transmission. One of more of the UEs may coordinate the selection of sidelink resources through a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots (discussed below). For example, the UE 404 is illustrated as having a sensing based resource selection component 450 that may monitor for resource reservations of other devices and select transmission resources from remaining sidelink resources.

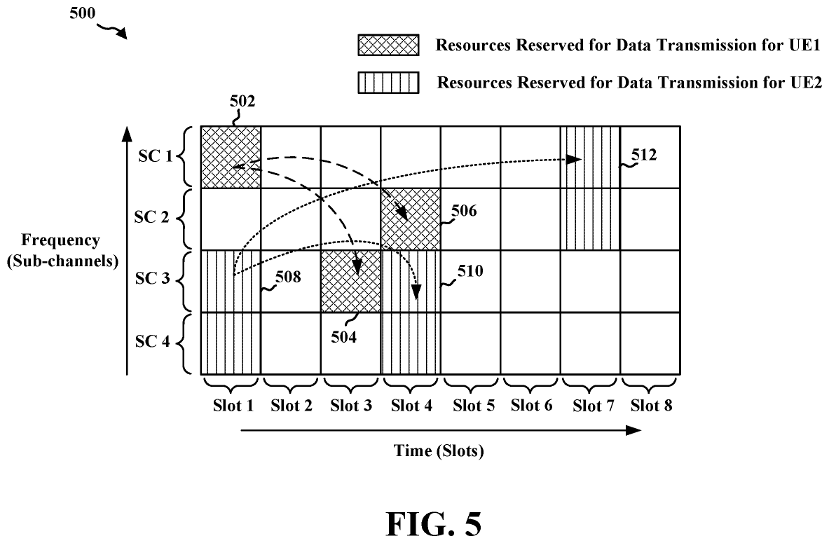

The UE 404 may employ resource selection for sidelink communication using a sensing-based mechanism. For instance, before selecting a resource for a data transmission, the UE 404 may first determine whether resources have been reserved by other UEs. For example, as part of a sensing mechanism for resource allocation mode 2, the UE 404 may determine (e.g., sense) whether the selected sidelink resource has been reserved by other UE(s) before selecting a sidelink resource for a data transmission. An example of sidelink resource reservation is described in connection with FIG. 5. Example aspects of a sensing mechanism is described in connection with FIG. 6. Sensing may include monitoring for sidelink resource reservations, e.g., in SCI, from other UEs. If the UE 404 determines that the sidelink resource has not been reserved by other UEs, the UE 404 may use the selected sidelink resource for transmitting the data, e.g., in a PSSCH transmission. The UE 404 may estimate or determine which radio resources (e.g., sidelink resources) may be in-use and/or reserved by others by detecting and decoding sidelink control information (SCI) transmitted by other UEs. The UE 404 may use a sensing-based resource selection algorithm to estimate or determine which radio resources are in-use and/or reserved by others. The UE 404 may receive SCI from another UE that includes reservation information based on a resource reservation field comprised in the SCI. The UE 404 may continuously monitor for (e.g., sense) and decode SCI from peer UEs. The UE 404 may perform partial sensing during particular periods of time. In some aspects, partial sensing may be based on a discontinuous reception (DRX) configuration/mode of the UE. The SCI may include reservation information, e.g., indicating slots and RBs that a particular UE has selected for a future transmission. The UE 404 may exclude resources that are used and/or reserved by other UEs from a set of candidate resources for sidelink transmission by the UE, and the UE 404 may select/reserve resources for a sidelink transmission from the resources that are unused and therefore form the set of candidate resources. The UE 404 may continuously/discontinuously perform sensing for SCI with resource reservations in order to maintain a set of candidate resources from which the UE 404 may select one or more resources for a sidelink transmission. Once the UE 404 selects a candidate resource, the UE 404 may transmit SCI indicating its own reservation of the resource for a sidelink transmission. The number of resources (e.g., sub-channels per subframe) reserved by the UE may depend on the size of data to be transmitted by the UE 404. Although the example is described for a UE 404 receiving reservations from another UE, the reservations may also be received from an RSU or other device communicating based on sidelink.

FIG. 5 is an example 500 of time and frequency resources showing reservations for sidelink transmissions. The resources may be comprised in a sidelink resource pool, for example. The resource allocation for each UE may be in units of one or more sub-channels in the frequency domain (e.g., sub-channels SC1 to SC 4), and may be based on one slot in the time domain. The UE may also use resources in the current slot to perform an initial transmission, and may reserve resources in future slots for retransmissions. In this example, two different future slots are being reserved by UE1 and UE2 for retransmissions. The resource reservation may be limited to a window of a pre-defined slots and sub-channels, such as an 8 time slots by 4 sub-channels window as shown in example 500, which provides 32 available resource blocks in total. This window may also be referred to as a resource selection window.

A first UE (“UE1) may reserve a sub-channel (e.g., SC 1) in a current slot (e.g., slot 1) for its initial data transmission 502, and may reserve additional future slots within the window for data retransmissions (e.g., 504 and 506). For example, UE1 may reserve sub-channels SC 3 at slots 3 and SC 2 at slot 4 for future retransmissions as shown by FIG. 4. UE1 then transmits information regarding which resources are being used and/or reserved by it to other UE(s). UE1 may do by including the reservation information in the reservation resource field of the SCI, e.g., a first stage SCI.

FIG. 5 illustrates that a second UE (“UE2”) reserves resources in sub-channels SC 3 and SC 4 at time slot 1 for its current data transmission 508, and reserve first data retransmission 510 at time slot 4 using sub-channels SC 3 and SC 4, and reserve second data retransmission 512 at time slot 7 using sub-channels SC 1 and SC 2 as shown by FIG. 5. Similarly, UE2 may transmit the resource usage and reservation information to other UE(s), such as using the reservation resource field in SCI.

A third UE may consider resources reserved by other UEs within the resource selection window to select resources to transmit its data. The third UE may first decode SCIs within a time period to identify which resources are available (e.g., candidate resources). For example, the third UE may exclude the resources reserved by UE1 and UE2 and may select other available sub-channels and time slots from the candidate resources for its transmission and retransmissions, which may be based on a number of adjacent sub-channels in which the data (e.g., packet) to be transmitted can fit.

While FIG. 5 illustrates resources being reserved for an initial transmission and two retransmissions, the reservation may be for an initial transmission and a single transmission or only for an initial transmission. The UE may determine an associated signal measurement (such as reference signal received power (RSRP)) for each resource reservation received by another UE. The UE may consider resources reserved in a transmission for which the UE measures an RSRP below a threshold to be available for use by the UE. A UE may perform signal/channel measurement for a sidelink resource that has been reserved and/or used by other UE(s), such as by measuring the RSRP of the message (e.g., the SCI) that reserves the sidelink resource. Based at least in part on the signal/channel measurement, the UE may consider using/reusing the sidelink resource that has been reserved by other UE(s). For example, the UE may exclude the reserved resources from a candidate resource set if the measured RSRP meets or exceeds the threshold, and the UE may consider a reserved resource to be available if the measured RSRP for the message reserving the resource is below the threshold. The UE may include the resources in the candidate resources set and may use/reuse such reserved resources when the message reserving the resources has an RSRP below the threshold, because the low RSRP indicates that the other UE is distant and a reuse of the resources is less likely to cause interference to that UE. A higher RSRP indicates that the transmitting UE that reserved the resources is potentially closer to the UE and may experience higher levels of interference if the UE selected the same resources.

For example, in a first step, the UE may determine a set of candidate resources (e.g., by monitoring SCI from other UEs and removing resources from the set of candidate resources that are reserved by other UEs in a signal for which the UE measures an RSRP above a threshold value). In a second step, the UE may select N resources for transmissions and/or retransmissions of a TB. As an example, the UE may randomly select the N resources from the set of candidate resources determined in the first step. In a third step, for each transmission, the UE may reserve future time and frequency resources for an initial transmission and up to two retransmissions. The UE may reserve the resources by transmitting SCI indicating the resource reservation. For example, in the example in FIG. 5, the UE may transmit SCI reserving resources for data transmissions 508, 510, and 512.

Additionally, or alternatively, to a full-sensing-based or a partial-sensing-based resource selection configuration, one or more of the UE's in FIG. 4 may include a random resource selection component 198 configured to select transmission resources randomly, e.g., using a mode 2 resource allocation without (or independent of) sensing for sidelink resource reservations from other UEs. For example, the UEs 402 and 406 are illustrated as having a random resource selection component 198.

The different resource selection configurations may be used to avoid conflicts or collisions with a specific resource selection configuration selected based on power saving considerations or a criticality of the sidelink transmission. As a random resource selection configuration may not be preceded by a sensing operation (e.g., as described in connection with FIG. 5, conflicts or collisions (overlapping in time or frequency) may occur between sidelink transmissions of different UEs. Aspects presented herein provide for conflict or collision reduction due to random resource selection performed by a UE from a same resource pool as a set of UEs each performing one of full-sensing-based or partial-sensing-based resource selection. In some aspects, the method additionally, or alternatively, may provide the conflict reduction while conserving energy at a UE performing the random resource selection.

FIG. 6 is a diagram 600 of a timeline for a full-sensing-based resource selection configuration. For example, the UE may sense and decode the SCI received from other UEs during a sensing window 602, e.g., a time duration prior to resource selection. Based on the sensing history during the sensing window 602, the UE may be able to identify and/or maintain a set of available candidate resources by excluding resources that are reserved by other UEs from the set of candidate resources. A UE may complete a resource selection from its set of available candidate resources at resource selection trigger 606 at a time T_{proc,0} after the end of the sensing window 602 and transmits SCI reserving the selected resources for sidelink transmission (e.g., a PSSCH transmission) in the resource selection window 604 by the UE. There may be a time gap between the UE's selection of the resources and the UE transmitting SCI reserving the resources. The full-sensing-based resource selection configuration illustrated in FIG. 6 may be performed with a period equal to T₀ plus T₂ (e.g., a period spanning a sensing window, a resource selection and signaling period (e.g., T_{proc,0} plus T₁), and a resource selection window 604).

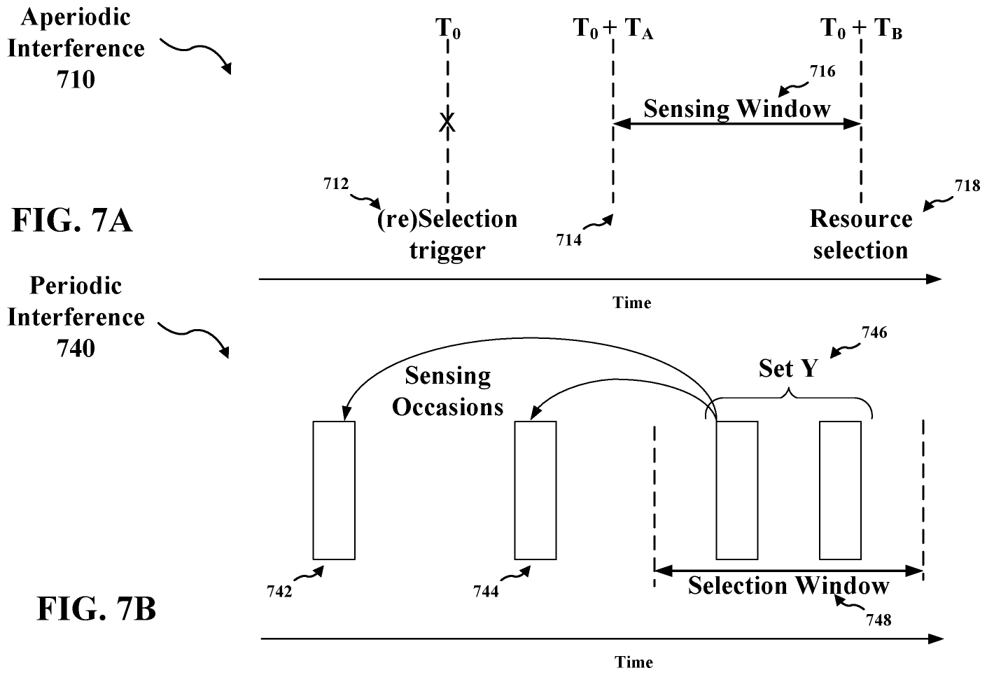

FIG. 7A includes a first diagram 710 illustrating a partial-sensing-based resource selection configuration for aperiodic interference and second diagram 740 illustrating a partial-sensing-based resource selection configuration for periodic interference. Diagram 710 illustrates that for aperiodic interference a (re)selection trigger 712 may occur at a time T₀ followed by a sensing window 716 between a time T₀+T_{A} 714 and a resource selection time (e.g., T₀+T_{B}) 718. While T_{A} and T_{B} are illustrated as taking positive values such that the sensing window 716 follows the (re) selection trigger 712, in some aspects, T_{A} and T_{B} may (1) take negative values such that the sensing window 716 occurs before a (re)selection trigger 712 and the selection is based on historical sensing data or (2) may be configured to be zero such that sensing is disabled.

Diagram 740 in FIG. 7B illustrates that, for periodic interference, a second most recent occasion 742 and a most recent occasion 744 of a periodic set of resources (e.g., resources configured for sidelink communication) may be identified as sensing occasions. The second most recent occasion 742 and the most recent occasion 744 may be monitored based on a configuration of a periodicity of a set of sidelink resources (e.g., a periodicity associated with a sl-ResourceReservePeriodList). Based on the sensing of the second most recent occasion 742 and the most recent occasion 744, a resource from a sidelink resource set ‘Y’ 746 may be selected during the selection window 748.

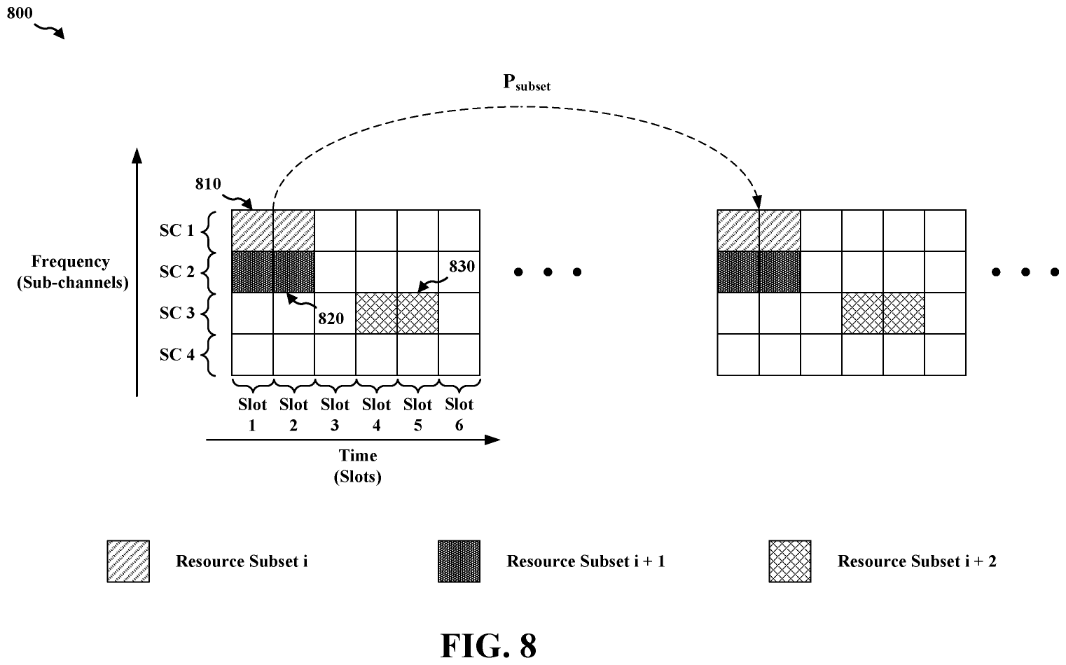

FIG. 8 is a diagram 800 illustrating resource subsets 810, 820, and 830 that may be configured as candidate resource subsets for a random resource selection operation. Each resource subset may correspond to a set of periodically occurring sidelink resources. The subsets may be formed from, or comprised in, an overall set of resources for random resource selection. Diagram 800 illustrates that for an example sidelink resource pool including a set of subchannels (e.g., SC1 to SC4) over a set of time slots (e.g., slots 1 to 8) including a group of resource subsets for random selection of sidelink resources, including resource subset i 810, resource subset i+1 820, and resource subset i+2 830. As diagram 800 illustrates, the set of resource subsets 810-830 may be repeated with a periodicity P_{subset}. As illustrated, in some aspects, the resources may be discontinuous in time. The resource subsets may be configured within a sidelink resource pool of frequency and/or time resources, for example. In some aspects, the UE may randomly select resources from the periodic resource subsets.

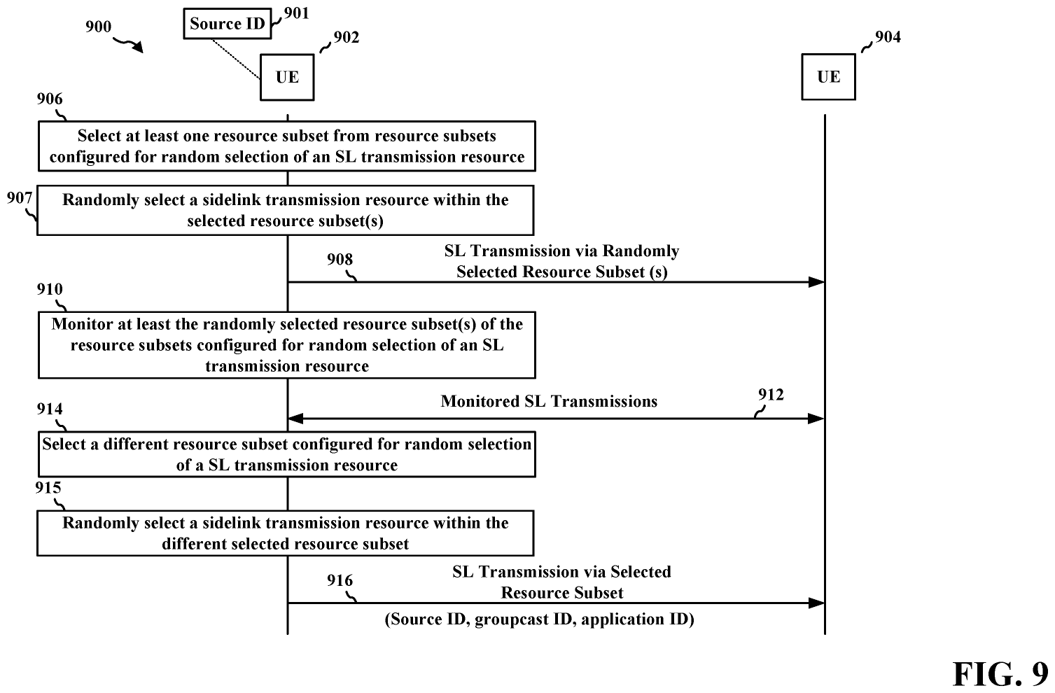

FIG. 9 is a call-flow diagram illustrating a set of operations associated with a random resource subset selection from a configured set of resource subsets for sidelink communication, in which a UE may perform at least a partial sensing to select a resource subset for random resource selection. In some aspects, a UE 902 may randomly select 906 at least one initial resource subset from a set of resource subsets configured for random selection of a sidelink transmission resource. In some aspects, in a random resource subset selection, the UE 902 may randomly select the at least one resource subset without a prior sensing operation to conserve power (e.g., for example at a mobile device for which power conservation is desirable). In other aspects, the UE 902 may select the resource subset based on at least partial sensing. Once the resource subset is selected, the UE may random select a transmission resource for a sidelink transmission, at 907. As an example, the UE may select the resource subset 1 from FIG. 8, and then may randomly select one or more frequency and/or time resource from the resource subset 1.

The UE 902 may transmit a sidelink transmission 908 via the randomly selected at resource. In addition to transmitting sidelink transmission 908, after randomly selecting 906 the at least one resource subset, the UE 902 may monitor 910 at least the selected resource subset(s). In some aspects, the monitoring 910 may be triggered by an indication that a threshold number (or percentage) of sidelink transmissions 908 transmitted via the randomly selected resource subset have failed to be decoded at the UE 904 (e.g., based on a number of ACKs or NACKs received from the receiving UE 904 in response to the sidelink transmissions transmitted by the UE 902). In some aspects, triggering the monitoring may allow the UE 902 to identify whether the selected resource subset is busy, e.g., resources within the selected resource subset are used by other devices using a full-sensing-based or partial-sensing-based resource selection that might otherwise conflict or collide with the randomly selected resource subset. If the UE 902 determines that the selected random resource set is busy (e.g., based on a channel busy ratio (CBR) or other measurement or trigger), the UE 902 may select a different resource subset configured for random resource selection, at 914. At 915, the UE 902 randomly selects a transmission resource from the different resource subset selected at 914. In some aspects, rather than a CBR, a decoding error threshold of one or more decoding errors may trigger the selection of a new resource subset for random resource selection. As an example, the UE may change from selection of the resource subset i in FIG. 8 to the resource subset i+1, and may randomly select a resource for the sidelink transmission 916 from the resource subset i+1. The UE may periodically monitor the CBR of the resource subset, and therefore may perform less processing than partial or full sensing and decoding of resource reservations. By using the CBR, or other trigger, to change resource subsets for random selection, the UE may reduce the likelihood of collisions/conflicts with other sidelink transmissions when transmission sidelink communication based on random resource selection within the resource subsets(s). Accordingly, the impact of random-selection-based resource selection on devices (e.g., UEs, IoT devices, vehicles, etc.) using full-sensing-based or partial-sensing-based resource selection may be minimized despite the other device being unable to anticipate a transmission via a randomly selected resource.

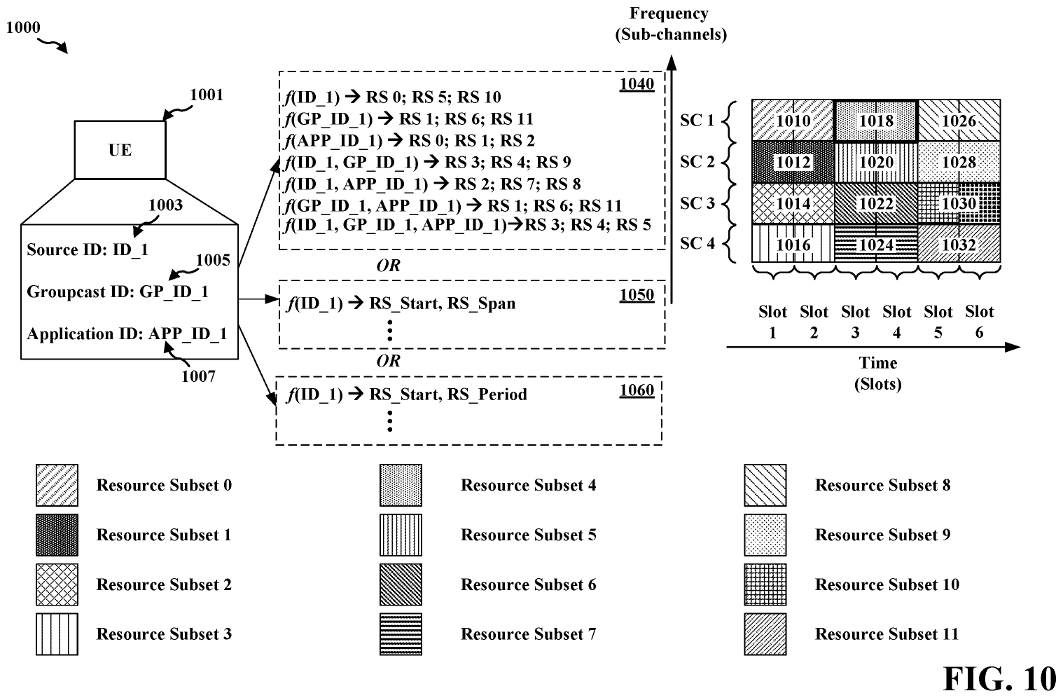

In some aspects, the UE 902 may also monitor 910, e.g., measure a CBR or other metric for, one or more additional resource subsets of the set of resource subsets configured for random selection of a sidelink transmission resource, e.g., in addition to the currently selected resource subset. The additional monitored resource subsets configured for random resource selection may be a configured subset based on a characteristic of the UE 902. For example, FIG. 10 is a diagram 1000 illustrating a configured set of resource subsets 1010, 1012, 1014, 1020, 1022, 1026, 1030, and 1032 (e.g., resource subsets 0-11) for sidelink communication. Diagram 10 illustrates that a particular UE 1001 may be configured to identify a subset of the resource subsets configured for random selection of a sidelink transmission resource based on at least one characteristic of the UE 1001. For example, the UE 1001 (or a particular transmission from the UE 1001) may be associated with one or more of a source ID 1003 (e.g., ID_1), a groupcast ID 1005 (e.g., GP_ID_1), or an application ID 1007 (e.g., APP_ID_1). The source ID 1003, the groupcast ID 1005, and/or the application ID 1007 may be used to identify a set of resource subsets e.g., resource subsets 0-11 1010-1032, from which the UE 1001 may select a resource subset in a random selection operation (e.g., selectable resource subsets).

The identified subset may be identified by a function of one or more of the characteristics of UE 1001 (e.g., f (ID_1), f (GP_ID_1), f (APP_ID_1), f (ID_1,GP_ID_1), f (ID_1,APP_ID_1), f (GP_ID_1,APP_ID_1), f (ID_,GP_ID_1, APP_ID_1) as indicated in the set of functions and outputs 1040). The function may be a hashing function, a mapping function, a modulo function, or any other function that assigns each ID to which it is applied to a particular set of resource subsets and has a roughly flat distribution across the different sets of resource subsets. The identified subset of resource subsets may be identified (1) by a list of resource subsets (e.g., lists in the set of functions and outputs 1040), (2) by a starting index (RS_Start) and a span (RS_Span) and/or number of resource subsets starting from the starting index 1050, or (3) by a starting index (RS_Start) and a periodicity of the resource subsets 1060 (e.g., a number of resource subsets intervening between selectable resource subsets in the configured set of resource subsets). For example, referring to FIGS. 9 and 10, a UE 902 (or 1001) may initially identify a set of resource subsets including resource subsets 3, 4, and 9 (e.g., resource subsets 1016, 1018, and 1028) based on a function of a source ID 1003 and a group ID 1005 (e.g., f (ID_1, GP_ID_1)→RS 3; RS 4; RS 9) and may randomly select 906 resource subset 4 (e.g., resource subset 1018) for a first sidelink transmission.

Continuing the example, after selecting the resource subset, the UE 902 (or 1001) may monitor 910, the resource subset 4 (e.g., resource subset 1018) or may monitor the set of resource subsets including each of resource subsets 3, 4, and 9 (e.g., resource subsets 1016, 1018, and 1028) identified based on the function of the characteristics of the UE 902 (or 1001). The UE 902 may monitor 910 all instances of the identified resource subsets or may monitor 910 the identified resource subsets periodically. The period of the monitoring, in some aspects, may be determined by the UE 902 based on local information (e.g., a current battery life, a local power saving configuration setting, the priority of the information to transmit via a sidelink transmission associated with the selectable resource subsets, etc.).

In some aspects, the UE monitors 910 (e.g., measures) one or more of an RSRP, a received signal strength indicator (RSSI), and/or a channel busy ratio (CBR) for a set of resource subsets with a configured period or based on a triggering event (e.g., as discussed above in relation to the decoding failures). The CBR, in some aspects, may be different from a reported CBR in that the CBR is associated with a resource subset and not with a particular UE (e.g., the monitored/measured CBR may reflect, or be based on, aggregated CBR data from a number of UEs). Although described as measuring one or more of an RSRP, an RSSI, and/or a CBR, the UE may monitor (or measure), at 910, a characteristic, factor, or metric associated with resource use for the set of resource subsets. In some aspects, the UE may monitor a characteristic, factor, or metric that is indicated by a network or that is configured based on an implementation of the UE. Although, diagram 900 illustrates that the monitored sidelink transmissions 912 originate at the UE 904, in practice the monitored sidelink transmissions 912 may originate from any device in the vicinity using the monitored resources (or resource subsets).

The UE 902 may switch resource subsets by selecting 914 a resource subset from a set of resource subsets configured for random selection of a sidelink transmission resource. The resource subset may be selected from the set of resource subsets configured for random selection of a sidelink transmission resource based on monitoring 910 at least the randomly selected resource subset(s) and determining that an RSRP or a CBR is above a threshold (indicating that a new resource subset should be selected). The UE 902 may select, at 915, a sidelink transmission resource from the resource subset selected at 914 (e.g., from the set of selectable resource subsets as described in relation to FIG. 10). The UE 902 may then transmit a sidelink transmission 916 via the resource selected at 915 by the UE 902. A sidelink message (e.g., 916) may be associated with a source ID 901 for the UE transmitting the message, a groupcast ID identifying group of UEs for which the transmission is intended to be received, and/or an application ID. In some aspects, the sidelink message may carry information about a source ID, groupcast ID, and/or application ID.

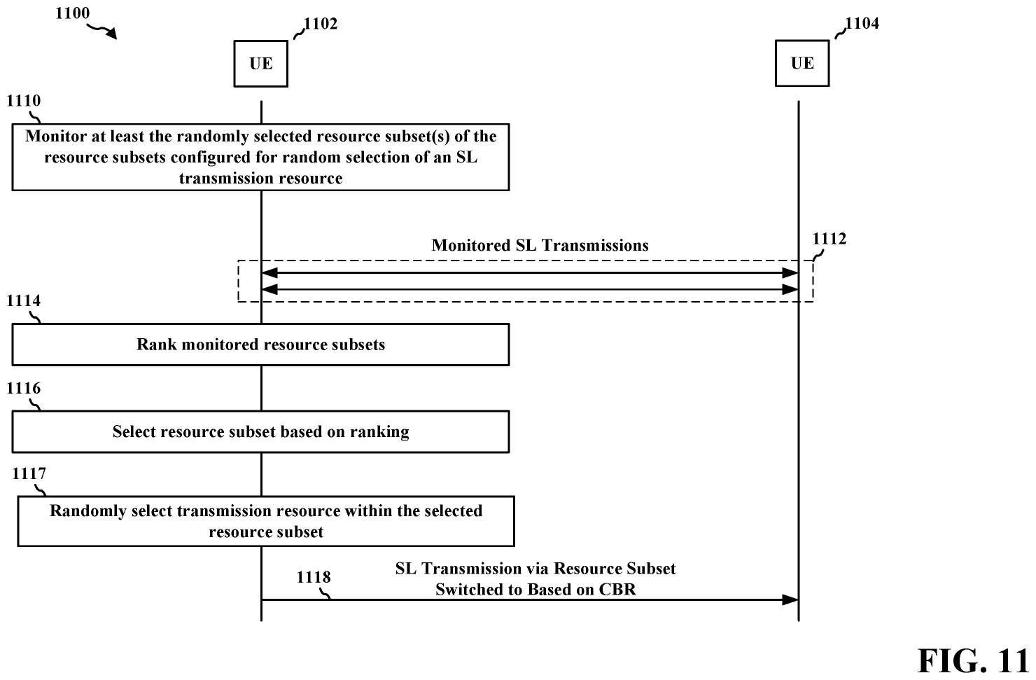

FIG. 11 is a call-flow diagram illustrating a set of operations associated with a random resource subset selection from a configured set of resource subsets for sidelink communication. A UE 1102 may monitor 1110 all, or a subset, of the configured set of resource subsets for sidelink communication. As described above in relation to FIG. 11, in some aspects, the monitoring 1110 may be triggered by an indication that a threshold number (or percentage) of sidelink messages transmitted via a randomly selected resource subset have failed to be decoded at the UE 1104 (e.g., based on a number of ACKs or NACKs received from the receiving UE 1104 in response to a sidelink transmissions transmitted by the UE 1102). In some aspects, triggering the monitoring may allow the UE 1102 to identify resources used by other devices using a full-sensing-based or partial-sensing-based resource selection that might otherwise conflict or collide with the randomly selected resource subset. Accordingly, the impact of random-selection-based resource selection on devices (e.g., UEs, IoT devices, vehicles, etc.) using full-sensing-based or partial-sensing-based resource selection may be minimized despite the other device being unable to anticipate a transmission via a randomly selected resource.

In some aspects, if the UE 1102 does not monitor all the resource subsets configured for random selection, a monitored subset of the set of resource subsets configured for random selection of a sidelink transmission resource may be a configured set of resource subsets based on a characteristic of the UE 1102. As discussed above in relation to FIG. 10, a particular UE 1001 may be configured to identify a subset of the resource subsets configured for random. The identified subset may be identified by a function of one or more of the characteristics of UE 1001 as indicated in the set of functions (e.g., 1040). The function may be a hashing function, a mapping function, a modulo function, or any other function that assigns each ID to which it is applied to a particular (sub) set of resource subsets and has a roughly flat distribution across the different (sub) sets of resource subsets. The identified subset of resource subsets may be identified (1) by a list of resource subsets (e.g., lists 1040), (2) by a starting index (RS_Start) and a span (RS_Span) and/or number of resource subsets starting from the starting index 1050, or (3) by a starting index (RS_Start) and a periodicity of the resource subsets 1060 (e.g., a number of resource subsets intervening between selectable resource subsets in the configured set of resource subsets). For example, referring to FIGS. 11 and 10, a UE 1102 (or 1001) may initially identify a set of resource subsets including resource subsets 3, 4, and 11 (e.g., resource subsets 1016, 1018, and 1028) based on a function of a source ID 1003 and a group ID 1005 (e.g., f (ID_1, GP_ID_1)→RS 3; RS 4; RS 11).

Continuing the example, the UE 1102 (or 1001) may monitor 1110, the set of resource subsets including each of resource subsets 3, 4, and 11 (e.g., resource subsets 1016, 1018, and 1028) identified based on the function of the characteristics of the UE 1102 (or 1001). The UE 1102 may monitor 1110 all instances of the identified resource subsets or may monitor 1110 the identified resource subsets periodically. The period of the monitoring, in some aspects, may be determined by the UE 1102 based on local information (e.g., a current battery life, a local power saving configuration setting, the priority of the information to transmit via a sidelink transmission associated with the selectable resource subsets, etc.).

In some aspects, the UE monitors 1110 (e.g., measures) an RSRP, an RSSI, and/or a CBR for each resource subset that it monitors (e.g., whether it monitors all, or a subset, of the set of resource subsets configured for random selection) with a configured period or based on a triggering event (e.g., as discussed above in relation to the decoding failures). The CBR, in some aspects, may be different from a reported CBR in that the CBR is associated with a resource subset and not with a particular UE (e.g., the monitored/measured CBR may reflect, or be based on, aggregated CBR data from a number of UEs). Although, diagram 1100 illustrates that the monitored sidelink transmissions 1112 originate at the UE 1104, in practice the monitored sidelink transmissions 1112 may originate from any device in the vicinity using the monitored resources (or resource subsets).

The UE 1102, may then rank 1114 the monitored resource subsets based on the measured RSRP or CBR. Based on the ranking, the UE 1102 may select, at 1116, at least one resource subset with a lowest CBR or RSRP. In some aspects, the UE 1102 may identify a candidate set of resource subsets from the monitored and ranked list of resource subsets. For example, the UE 1102 may identify a set of candidate resource subsets as including those monitored resource subsets with an RSRP or CBR that is below a threshold value. The threshold value may be a configured fixed threshold value or a variable threshold value based on the measured values such that a configured fraction of the monitored resource subsets is identified as candidate resource subsets. After selecting the resource subset, at 1117, the UE 1102 may randomly select a resource for a sidelink transmission from within the resource subset selected at 1116. In some aspects, the UE may select the resource subset having a measurement that indicates that the subset is the least busy subset, e.g., having a lowest CBR among the set of resource subsets. The UE 1102 may then transmit a sidelink transmission 1118 via the resource subset selected 1114 by the UE 1102.

In some aspects, the UE may perform a periodic sensing, e.g., to save power. In some aspects, the sensing may be an on-demand sensing. For example, the UE may perform the partial sensing aspects described herein, e.g., with partial measurements of resource subsets. The period of the on-demand sensing, or discontinuous sensing/measurement may be increased in order to increase power saving at the UE. In some aspects, a UE may be assigned or may select a resource subset for random selection of sidelink resources based on a rule. As an example, sidelink UEs may transmit sidelink communication with random resource selection within a particular resource subset index that is based on a source ID associated with the UE. As another example, sidelink UEs may transmit sidelink communication with random resource selection within a particular resource subset having a subchannel index or periodicity that maps to, or is otherwise associated with, the source ID of the UE. As another example, sidelink UEs may transmit sidelink communication with random resource selection within a particular resource subset index that is based on an application ID or groupcast ID of the sidelink communication. For example, FIG. 9 illustrates that a sidelink message (e.g., 916) may be associated with a source ID 901 for the UE transmitting the message, a groupcast ID identifying group of UEs for which the transmission is intended to be received, and/or an application ID. In some aspects, the sidelink message may carry information about a source ID, groupcast ID, and/or application ID. The use of a rule, or non-random selection of the resource subset, may help to distribute random selection UEs to varied resource subsets in order to avoid many UEs selecting the same resource subset. The UEs may then randomly select resources for a sidelink transmission from within the assigned/designated resource subset.

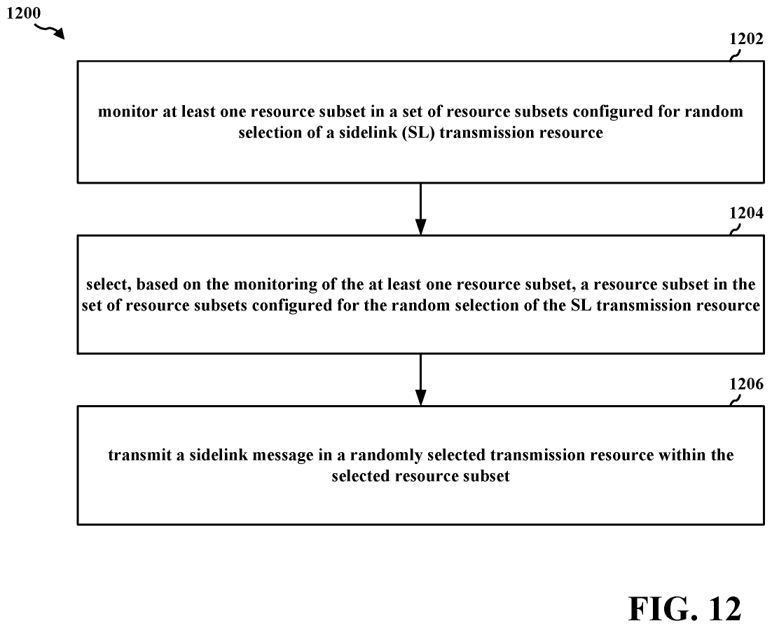

FIG. 12 is a flowchart 1200 of a method of wireless communication. The method may be performed by a UE (e.g., the UE 104, 902, 1001, 1102; the apparatus 1402). At 1202, the UE may monitor at least one resource subset in a set of resource subsets configured for random selection of a sidelink transmission resource. In some aspects, the at least one resource subset may be monitored based on at least one of a UE source identifier associated with the UE, a groupcast identifier associated with the UE, or an application identifier associated with the UE. For example, 1202 may be performed by resource subset monitoring component 1442. Monitoring, at 1202, the at least one resource subset, in some aspects, may include monitoring and/or measuring at least one of an RSRP, an RSSI, a CBR, or a set of decoding failures to determine whether the at least one resource subset meets a selection metric. In some aspects, monitoring, at 1202, the at least one resource subset includes monitoring a current selected resource subset of the set of resource subsets configured for the random selection of the sidelink transmission resource. The at least one resource subset, in some aspects, may include each resource subset in the set of resource subsets configured for the random selection of the sidelink transmission resource and each resource subset may have an RSRP, an RSSI, and/or a CBR monitored at 1202.

In some aspects, the UE may monitor, at 1202, an RSRP, an RSSI, and/or a CBR of a subset of the set of resource subsets in the set of resource subsets associated with sidelink communication. As discussed above in relation to FIGS. 9-11, the subset of the set of resource subsets may be based on one of a UE source identifier associated with the UE, a groupcast identifier associated with the UE, or an application identifier associated with the UE. The monitoring, at 1202, may be periodic monitoring that monitors all, or less than all, occasions of the at least one resource subset. In some aspects, the periodicity may be determined by the UE based on local configurations or conditions (e.g., a current power level, an energy conservation configuration, etc.). The periodicity, in some aspects, may be based on at least one of a UE source identifier, a groupcast identifier, or an application identifier.

For example, referring to FIGS. 9-11, a UE 902 or 1102 may monitor 910 or 1110 an RSRP, an RSSI, and/or a CBR, of at least one resource subset 1018. In some aspects, the UE 902 or 1102 may monitor 910 or 1110 a set of resource subsets identified based on one or more of a UE source identifier 1003 associated with the UE, a groupcast identifier 1005 associated with the UE, or an application identifier 1007 associated with the UE. For example, identifying the set of resource subsets at 1202 may be performed by resource subset identification component 1440. The set of resource subsets may define a set of selectable resource subsets that includes less than all of the resource subsets in the set of resource subsets configured for random selection. In some aspects, the at least one resource subset include the entire set of resource subsets configured for random selection (e.g., resource subsets 1010-1032).

At 1204, the UE may select, based on the monitoring of the at least one resource subset, a resource subset in the set of resource subsets configured for the random selection of the sidelink transmission resource. In some aspects in which a resource subset has previously been selected, selecting, at 1204, the at least one resource may include switching from the prior (e.g., previously selected) resource subset for the random selection of the sidelink transmission resource based on a CBR for the prior resource subset exceeding a threshold. The at least one resource subset may be selected at 1204 from a set of candidate resource subsets having a measured RSRP, measured RSSI, or measured CBR below a threshold. Selecting, at 1204 the at least one resource may include at least one of randomly selecting one resource subset in the set of candidate resource subsets or selecting the resource subset with a lowest associated RSRP, RSSI or CBR from the set of candidate resource subsets. For example, 1204 may be performed by resource subset selection component 1444.

Finally, at 1206, the UE may transmit a sidelink message in a randomly selected transmission resource within the selected resource subset. For example, referring to FIGS. 9-11, the UE 902 or 1102 may transmit a sidelink transmission 916 or 1118 via the resource subset selected at 1204. As the sidelink message (e.g., sidelink transmission 916 or 1118) may not utilize all the transmission resources of a selected resource subset a particular transmission resource (e.g., symbol or set of symbols across a subcarrier or multiple subcarriers for a resource subset that includes multiple symbols and subcarriers) may be selected for the transmission at 1204. For example, 1206, may be performed by resource subset selection component 1444.

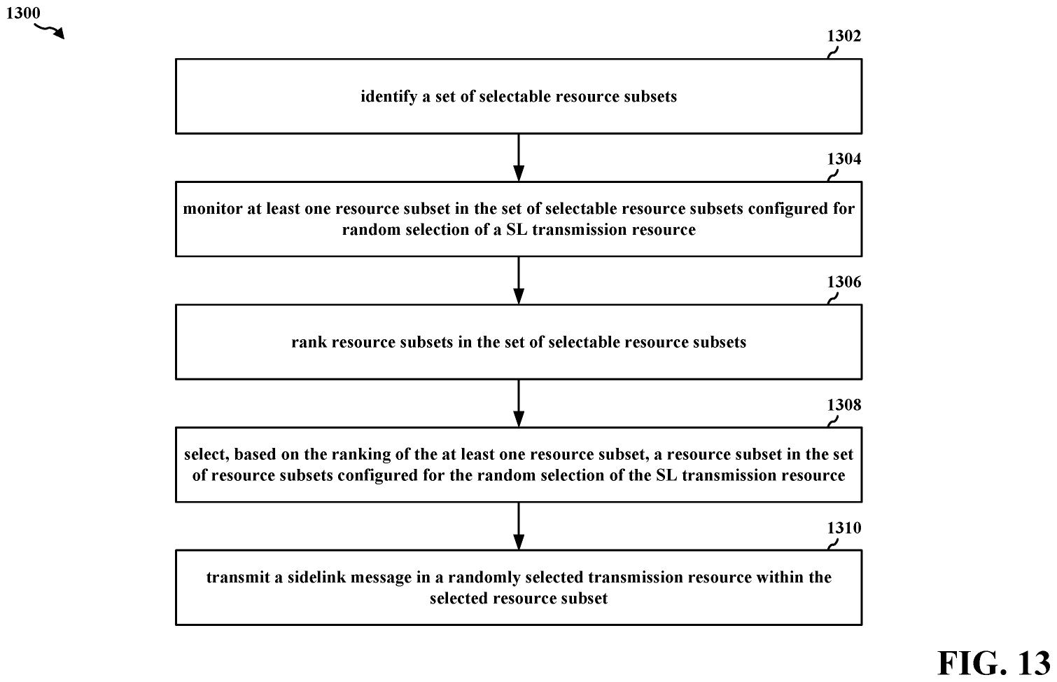

FIG. 13 is a flowchart 1300 of a method of wireless communication. The method may be performed by a UE (e.g., the UE 104, 902, 1001, 1102; the apparatus 1402). At 1302, the UE may identify a set of selectable resource subsets in a set of resource subsets configured for random selection of a sidelink transmission resource. For example, 1202 may be performed by resource subset identification component 1440. As discussed above in relation to FIGS. 9-11, the set of selectable resource subsets may be based on one of a UE source identifier associated with the UE, a groupcast identifier associated with the UE, or an application identifier associated with the UE. For example, referring to FIGS. 9-11, a UE 902 or 1102 may identify a set of selectable resource subsets based on one or more of a UE source identifier 1003 associated with the UE, a groupcast identifier 1005 associated with the UE, or an application identifier 1007 associated with the UE. The set of selectable resource subsets may include less than all of the resource subsets in the set of resource subsets configured for random selection. In some aspects, the at least one resource subset include the entire set of resource subsets configured for random selection (e.g., resource subsets 1010-1032). The set of selectable resource subsets, in some aspects, may include each resource subset in the set of resource subsets configured for the random selection of the sidelink transmission resource

At 1304, the UE may monitor at least one resource subset in the set of selectable resource subsets configured for random selection of a sidelink transmission resource. For example, 1302 may be performed by resource subset monitoring component 1442. Monitoring, at 1302, the at least one resource subset, in some aspects, may include monitoring and/or measuring at least one of an RSRP, an RSSI, a CBR, or a set of decoding failures to determine whether the at least one resource subset meets a selection metric. For example, the monitoring may include comparing one or more of the RSRP, RSSI, or CBR to the selection metric. In some aspects, monitoring, at 1304, the at least one resource subset includes monitoring a current selected resource subset of the set of resource subsets configured for the random selection of the sidelink transmission resource.

The monitoring, at 1302, may be periodic monitoring that monitors all, or less than all, occasions of the at least one resource subset. In some aspects, the periodicity may be determined by the UE based on local configurations or conditions (e.g., a current power level, an energy conservation configuration, etc.). The periodicity, in some aspects, may be based on at least one of a UE source identifier, a groupcast identifier, or an application identifier. For example, referring to FIGS. 9-11, a UE 902 or 1102 may monitor 910 or 1110 an RSRP, an RSSI, and/or a CBR, of at least one resource subset 1018.

At, 1306, the UE may rank the monitored set of selectable resource subsets based on monitoring, at 1304, one of a measured RSRP, measured RSSI, or measured CBR. The UE may rank the monitored resource subsets and identify a set of candidate resource subsets with an RSRP, RSSI, or CBR, that is below a threshold value. A candidate resource subset may correspond to a resource subset that is selectable based on having a measurement that meets a threshold value, e.g., such as an RSRP, RSSI, or CBR below the threshold value. As discussed above in relation to FIG. 11, the threshold may be a configured static value or may be configured to identify a particular number of (or fraction of) resource subsets having a lowest associated RSRP, a lowest associated RSSI, or a lowest associated CBR value in the set of monitored resource subsets. For example, a measurement (e.g., RSRP, RSSI, or CBR) may be performed for each of the resource subsets, and the UE may select the resource subset that has the lowest measurement (e.g., RSRP, RSSI, or CBR) among the measured resource subsets. For example, 1306 may be performed by a resource subset selection component 1444.

At 1308, the UE may select a resource subset from the set of candidate resource subsets based on the ranking. Selecting, at 1308 the at least one resource may include at least one of randomly selecting one resource subset in the set of candidate resource subsets or selecting the resource subset with a lowest associated RSRP, RSSI or CBR from the set of candidate resource subsets. For example, 1308 may be performed by resource subset selection component 1444. For example, referring to FIGS. 10 and 11, the UE 1102 may select 1116 a resource subset based on the ranking.

Finally, at 1310, the UE may transmit a sidelink message in a randomly selected transmission resource within the selected resource subset. For example, referring to FIGS. 9-11, the UE 902 or 1102 may transmit a sidelink transmission 916 or 1118 via the resource subset selected at 1304. As the sidelink message (e.g., sidelink transmission 916 or 1118) may not utilize all the transmission resources of a selected resource subset a particular transmission resource (e.g., symbol or set of symbols across a subcarrier or multiple subcarriers for a resource subset that includes multiple symbols and subcarriers) may be selected for the transmission at 1308. For example, 1310 may be performed by resource subset selection component 1444.

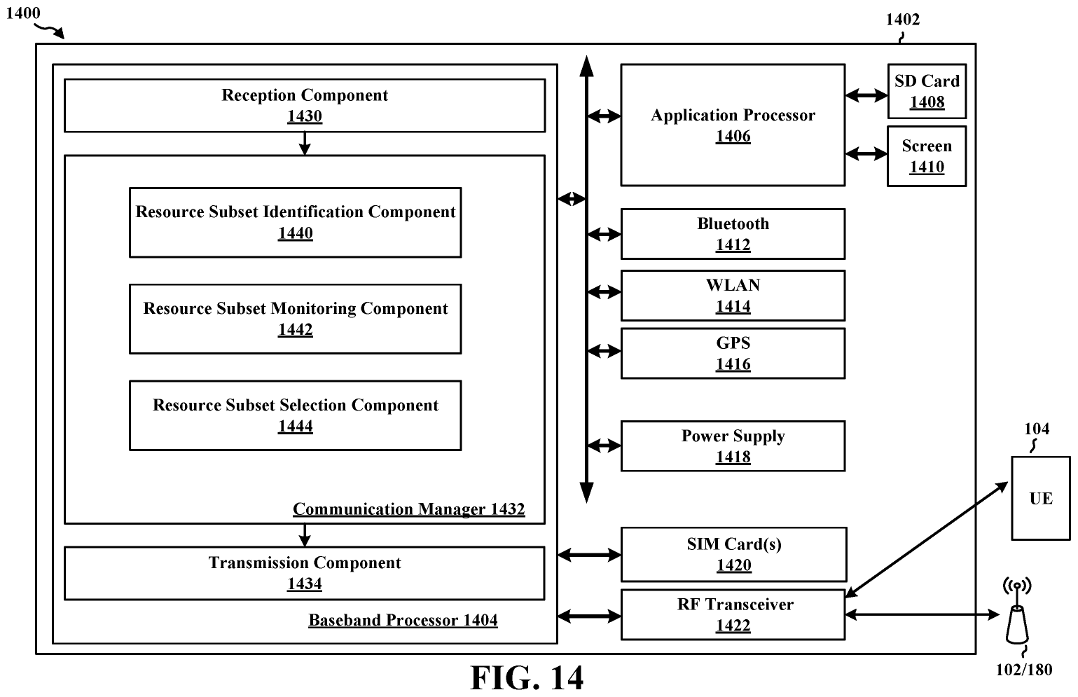

FIG. 14 is a diagram 1400 illustrating an example of a hardware implementation for an apparatus 1402. The apparatus 1402 may be a UE, a component of a UE, or may implement UE functionality. In some aspects, the apparatus 1402 may include a baseband processor 1404 (also referred to as a modem) coupled to a RF transceiver 1422. In some aspects, the baseband processor 1404 may be a cellular baseband processor, and the RF transceiver 1422 may be a cellular RF transceiver. In some aspects, the apparatus 1402 may further include one or more subscriber identity modules (SIM) cards 1420, an application processor 1406 coupled to a secure digital (SD) card 1408 and a screen 1410, a Bluetooth module 1412, a wireless local area network (WLAN) module 1414, a Global Positioning System (GPS) module 1416, or a power supply 1418. The baseband processor 1404 communicates through the RF transceiver 1422 with the UE 104 and/or BS 102/180. The baseband processor 1404 may include a computer-readable medium/memory. The computer-readable medium/memory may be non-transitory. The baseband processor 1404 is responsible for general processing, including the execution of software stored on the computer-readable medium/memory. The software, when executed by the baseband processor 1404, causes the baseband processor 1404 to perform the various functions described supra. The computer-readable medium/memory may also be used for storing data that is manipulated by the baseband processor 1404 when executing software. The baseband processor 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the baseband processor 1404. The baseband processor 1404 may be a component of the device 350 and may include the memory 360 and/or at least one of the TX processor 368, the RX processor 356, and the controller/processor 359. In one configuration, the apparatus 1402 may be a modem chip and include just the baseband processor 1404, and in another configuration, the apparatus 1402 may be the entire UE (e.g., see 350 of FIG. 3) and include the additional modules of the apparatus 1402.

The communication manager 1432 includes a resource subset identification component 1440 that is configured to select, based on the monitoring of the at least one resource subset, a resource subset in the set of resource subsets configured for the random selection of the SL transmission resource, e.g., as described in connection with 1202 in FIG. 12 or 1308 in FIG. 13. The communication manager 1432 further includes a resource subset monitoring component 1442 that is configured to monitor at least one resource subset in a set of resource subsets configured for random selection of a SL transmission resource, e.g., as described in connection with 1202 in FIG. 12 or 1304 in FIG. 13. The communication manager 1432 further includes a resource subset selection component 1444 that is configured to transmit a sidelink message in a randomly selected transmission resource within the selected resource subset, e.g., as described in connection with 1206 in FIG. 12 or 1310 in FIG. 13.

The apparatus may include additional components that perform each of the blocks of the algorithm in the flowcharts of FIG. 12 or 13, and/or the aspects performed by the UE 902 and/or 1102 in FIGS. 9 and/or 11. As such, each block in the flowcharts of FIG. 12 or 13, and/or the aspects performed by the UE 902 and/or 1102 in FIGS. 9 and/or 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1402 may include a variety of components configured for various functions. In one configuration, the apparatus 1402, and in particular the baseband processor 1404, includes means for monitoring at least one resource subset in a set of resource subsets configured for random selection of a sidelink transmission resource. The apparatus 1402, and in particular the baseband processor 1404, may also include means for selecting, based on the monitoring of the at least one resource subset, a resource subset in the set of resource subsets configured for the random selection of the sidelink transmission resource. The apparatus 1402, and in particular the baseband processor 1404, may further include means for transmitting a sidelink message in a randomly selected transmission resource within the selected resource subset. The apparatus 1402, and in particular the baseband processor 1404, may further include means for ranking each resource subset in the set of resource subsets with an order based on the measured RSRP, the measured RSSI, or the measured CBR. The means may be one or more of the components of the apparatus 1402 configured to perform the functions recited by the means. As described supra, the apparatus 1402 may include the TX Processor 368, the RX Processor 356, and the controller/processor 359. As such, in one configuration, the means may be the TX Processor 368, the RX Processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication at a UE, comprising: monitoring at least one resource subset in a set of resource subsets configured for random selection of a sidelink transmission resource; selecting, based on the monitoring of the at least one resource subset, a resource subset in the set of resource subsets configured for the random selection of the sidelink transmission resource; and transmitting a sidelink message in a randomly selected transmission resource within the selected resource subset.

In aspect 2, the method of aspect 1 further includes that monitoring the at least one resource subset comprises comparing one or more of a RSRP or a set of decoding failures to a selection metric.

In aspect 3, the method of aspect 1 or aspect 2 further includes switching from a prior resource subset for the random selection of the sidelink transmission resource based on a CBR for the prior resource subset exceeding a threshold.

In aspect 4, the method of aspect 3 further includes that the resource subset is a randomly selected resource set from the set of resource subsets in response to the prior resource subset having the CBR exceeding the threshold.

In aspect 5, the method of any of aspects 1-4 further includes that monitoring the at least one resource subset includes monitoring a current selected resource subset of the set of resource subsets configured for the random selection of the sidelink transmission resource.

In aspect 6, the method of any of aspects 1-4 further includes that monitoring the at least one resource subset comprises measuring one or more of a RSRP, a RSSI, or a CBR for each resource subset in the set of resource subsets configured for the random selection of the sidelink transmission resource.

In aspect 7, the method of aspect 6 further includes that the resource subset is selected from a set of candidate resource subsets having a measured RSRP, a measured RSSI, or a measured CBR below a threshold.

In aspect 8, the method of aspect 6 further includes that the resource subset comprises randomly selecting one resource subset in the set of candidate resource subsets.

In aspect 9, the method of aspect 6 or aspect 8 further includes that selecting the resource subset comprises selecting the resource subset with a lowest associated RSRP, a lowest associated RSSI, or a lowest associated CBR from the set of candidate resource subsets.

In aspect 10, the method of any of aspects 7, 8, or 9 further includes ranking each resource subset in the set of resource subsets with an order based on the measured RSRP, the measured RSSI, or the measured CBR.

In aspect 11, the method of any of aspects 1-4 further includes that monitoring the at least one resource subset comprises measuring one or more of a RSRP, a RSSI, or a CBR for a subset of the set of resource subsets in the set of resource subsets associated with sidelink communication.

In aspect 12, the method of aspect 11 further includes that the subset of the set of resource subsets is based on one of a UE source identifier associated with the UE, a groupcast identifier associated with the UE, or an application identifier associated with the UE, wherein the resource subset is selected from the subset of the set of resource subsets.

In aspect 13, the method of any of aspects 1-4 further includes that the at least one resource subset is monitored based on at least one of a UE source identifier associated with the UE, a groupcast identifier associated with the UE, or an application identifier associated with the UE.

In aspect 14, the method of any of aspects 1-13 further includes that the monitoring is a periodic monitoring.

In aspect 15, the method of aspect 14 further includes that a period of the periodic monitoring is based on at least one of a UE source identifier, a groupcast identifier, or an application identifier.

Aspect 16 is an apparatus for wireless communication including memory and at least one processor coupled to the memory, the memory and the at least one processor configured to perform the method of any of aspects 1 to 15.

In aspect 17, the apparatus of aspect 16 further includes at least one transceiver coupled to the at least one processor.

In aspect 18, the apparatus of aspect 16 or aspect 17 further includes at least one antenna coupled to the at least one processor.

Aspect 19 is an apparatus for wireless communication including means for implementing the method of any of aspects 1 to 15.

In aspect 20, the apparatus of aspect 19 further includes at least one transceiver.

In aspect 21, the apparatus of aspect 19 or aspect 20 further includes at least one antenna.

Aspect 22 is a non-transitory computer-readable storage medium storing computer executable code, where the code when executed by a processor causes the processor to implement any of aspects 1 to 15.

What is claimed is:

1. An apparatus for wireless communication at a user equipment (UE) comprising:
a memory; and
at least one processor coupled to the memory and configured to:
monitor at least one resource subset in a set of resource subsets configured for random selection of a sidelink transmission resource;
select, from the at least one resource subset monitored by the UE, a resource subset in the set of resource subsets configured for the random selection of the sidelink transmission resource; and
transmit a sidelink message in a randomly selected transmission resource within the selected resource subset.

2. The apparatus of claim 1, wherein to monitor the at least one resource subset, the memory and the at least one processor are further configured to compare one or more of a reference signal received power (RSRP) or a set of decoding failures to a selection metric.

3. The apparatus of claim 2, wherein to select the resource subset, the memory and the at least one processor are further configured to:
switch from a prior resource subset for the random selection of the sidelink transmission resource based on a channel busy ratio (CBR) for the prior resource subset exceeding a threshold.

4. The apparatus of claim 3, wherein the resource subset is a randomly selected resource set from the set of resource subsets in response to the prior resource subset having the CBR exceeding the threshold.

5. The apparatus of claim 1, wherein to monitor the at least one resource subset, the memory and the at least one processor are configured to monitor a current selected resource subset of the set of resource subsets configured for the random selection of the sidelink transmission resource.

6. The apparatus of claim 1, wherein to monitor the at least one resource subset, the memory and the at least one processor are further configured to measure one or more of a reference signal received power (RSRP), a received signal strength indicator (RSSI), or a channel busy ratio (CBR) for each resource subset in the set of resource subsets configured for the random selection of the sidelink transmission resource.

7. The apparatus of claim 6, wherein the resource subset is selected from a set of candidate resource subsets having a measured RSRP, a measured RSSI, or a measured CBR below a threshold.

8. The apparatus of claim 7, wherein to select the resource subset, the memory and the at least one processor are configured to randomly select one resource subset in the set of candidate resource subsets.

9. The apparatus of claim 7, wherein to select the resource subset, the memory and the at least one processor are configured to select the resource subset with a lowest associated RSRP, a lowest associated RSSI, or a lowest associated CBR from the set of candidate resource subsets.

10. The apparatus of claim 7, wherein the memory and the at least one processor are further configured to:
rank each resource subset in the set of resource subsets with an order based on the measured RSRP, the measured RSSI, or the measured CBR.

11. The apparatus of claim 1, wherein to monitor the at least one resource subset, the memory and the at least one processor is configured to measure one or more of a reference signal received power (RSRP), a received signal strength indicator (RSSI), or a channel busy ratio (CBR) for a subset of the set of resource subsets in the set of resource subsets associated with sidelink communication.

12. The apparatus of claim 11, wherein the subset of the set of resource subsets is based on one of a UE source identifier associated with the UE, a groupcast identifier associated with the UE, or an application identifier associated with the UE, wherein the resource subset is selected from the subset of the set of resource subsets.

13. The apparatus of claim 1, wherein the at least one resource subset is monitored based on at least one of a UE source identifier associated with the UE, a groupcast identifier associated with the UE, or an application identifier associated with the UE.

14. The apparatus of claim 1, wherein to monitor the at least one resource subset, the memory and the at least one processor are configured to perform a periodic monitoring.

15. The apparatus of claim 14, wherein a period of the periodic monitoring is based on at least one of a UE source identifier, a groupcast identifier, or an application identifier.

16. The apparatus of claim 1, further comprising at least one antenna coupled to the at least one processor.

17. A method of wireless communication at a user equipment (UE), comprising:
monitoring at least one resource subset in a set of resource subsets configured for random selection of a sidelink transmission resource;
selecting, based on the monitoring of the at least one resource subset, a resource subset in the set of resource subsets configured for the random selection of the sidelink transmission resource; and
transmitting a sidelink message in a randomly selected transmission resource within the selected resource subset.

18. The method of claim 17, wherein monitoring the at least one resource subset includes monitoring a current selected resource subset of the set of resource subsets configured for the random selection of the sidelink transmission resource.

19. The method of claim 17, wherein monitoring the at least one resource subset comprises measuring one or more of a reference signal received power (RSRP), a received signal strength indicator (RSSI), or a channel busy ratio (CBR) for each resource subset in the set of resource subsets configured for the random selection of the sidelink transmission resource.

20. The method of claim 19, wherein the resource subset is selected from a set of candidate resource subsets having a measured RSRP, a measured RSSI, or a measured CBR below a threshold.

21. The method of claim 20, wherein selecting the resource subset comprises randomly selecting one resource subset in the set of candidate resource subsets.

22. The method of claim 20, wherein selecting the resource subset comprises selecting the resource subset with a lowest associated RSRP, a lowest associated RSSI, or a lowest associated CBR from the set of candidate resource subsets.

23. The method of claim 20, further comprising:
ranking each resource subset in the set of resource subsets with an order based on the measured RSRP, the measured RSSI, or the measured CBR.

24. The method of claim 17, wherein monitoring the at least one resource subset comprises measuring one or more of a reference signal received power (RSRP), a received signal strength indicator (RSSI), or a channel busy ratio (CBR) for a subset of the set of resource subsets in the set of resource subsets associated with sidelink communication.

25. The method of claim 24, wherein the subset of the set of resource subsets is based on one of a UE source identifier associated with the UE, a groupcast identifier associated with the UE, or an application identifier associated with the UE, wherein the resource subset is selected from the subset of the set of resource subsets.

26. The method of claim 17, wherein the at least one resource subset is monitored based on at least one of a UE source identifier associated with the UE, a groupcast identifier associated with the UE, or an application identifier associated with the UE.

27. The method of claim 17, wherein the monitoring is a periodic monitoring.

28. The method of claim 27, wherein a period of the periodic monitoring is based on at least one of a UE source identifier, a groupcast identifier, or an application identifier.

29. An apparatus for wireless communication at a user equipment (UE) comprising:
means for monitoring at least one resource subset in a set of resource subsets configured for random selection of a sidelink transmission resource;
means for selecting, based on the monitoring of the at least one resource subset, a resource subset in the set of resource subsets configured for the random selection of the sidelink transmission resource; and
means for transmitting a sidelink message in a randomly selected transmission resource within the selected resource subset.

30. A computer-readable medium storing computer executable code at a user equipment (UE), the code when executed by a processor causes the processor to:
monitor at least one resource subset in a set of resource subsets configured for random selection of a sidelink transmission resource;
select, from the at least one resource subset monitored by the UE, a resource subset in the set of resource subsets configured for the random selection of the sidelink transmission resource; and
transmit a sidelink message in a randomly selected transmission resource within the selected resource subset.
